(19) United States
(12) Patent Application Publication
(10) Pub. No.: US 2014/0333788 A1
(43) Pub. Date: Nov. 13, 2014

(54) DEVICE AND METHOD FOR PROCESSING IMAGE CONTENT

(71) Applicants: SONY CORPORATION, Tokyo (JP); SONY NETWORK ENTERTAINMENT INTERNATIONAL LLC, Los Angeles, CA (US)

(72) Inventors: True Xiong, San Diego, CA (US); Charles McCoy, Coronado, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/888,701

(22) Filed: May 7, 2013

(51) Int. Cl. H04N 5/232

(52) U.S. Cl. CPC H04N 5/23245
USPC 348/220.1

(57) ABSTRACT

Various aspects of a device and a method for processing image content by a device are disclosed herein. The device captures image content based on one or more predetermined events. The device detects a change in a mode of operation of the device from a first mode of operation to a second mode of operation associated with capturing of the image content. The device renders an output in response to the detected change in the mode of operation of the device. The rendered output is one or more of an audio output or an output non-perceivable by a human.

### FIELD

Various embodiments of the disclosure relate to processing image content.

### BACKGROUND

Recent developments in digital imaging devices have seen a move towards better interactive capabilities in digital imaging devices. For example, a digital imaging device may display a message in response to an input from an operating user. However, the interactive responses from the digital imaging device may be limited in capabilities and may degrade the overall experience of the operating user. Thus, such interactive responses from the digital imaging device may be undesirable in certain scenarios.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A device and method are provided for processing image content substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram of an exemplary device, in accordance with an embodiment of the disclosure.

FIG. 2 illustrates an exemplary instance of an exemplary device for determining a key frame in a captured audio-visual content, in accordance with an embodiment of the disclosure.

FIG. 3 is a flow chart illustrating exemplary steps for processing image content, in accordance with an embodiment of the disclosure.

FIG. 4 is another flow chart illustrating exemplary steps for processing image content, in accordance with an embodiment of the disclosure.

### DETAILED DESCRIPTION

The following described implementations may be found in a device and/or a method for processing image content.

Exemplary aspects of the disclosure may comprise a method for processing image content by a device. The method may include detecting a change in a mode of operation of the device from a first mode of operation to a second mode of operation associated with capturing of the image content. The method may include rendering an output in response to the detected change in the mode of operation of the device. The rendered output may be an audio output or an output non-perceivable by the human.

In an embodiment, the first mode of operation of the device may be an image capture mode. Such image capture mode may be associated with capturing of image content. In an embodiment, the second mode of operation of the device may be a video capture mode. Such video capture mode may be associated with capturing of audio-visual content.

In an embodiment, the method may include switching from the first mode of operation to the second mode of operation in response to one or more predetermined events.

In an embodiment, the one or more predetermined events may include detecting a predetermined user input, detecting a movement of one or more objects in said image content, detecting a physical movement of the device, detecting a change in an orientation of the device, and/or detecting a change in one or more settings of the device.

In an embodiment, the one or more predetermined user input events may include a set of gestures. The set of gestures may include a hand gesture, a finger gesture, a facial gesture and/or a body gesture.

In an embodiment, the method may include storing one or more time-stamps in the captured audio-visual content, based on an occurrence of the one or more predetermined events.

In an embodiment, the method may include controlling the capture of the audio-visual content, based on the stored one or more time-stamps.

In an embodiment, the method may include capturing the image content in the first mode of operation and the second mode of operation simultaneously.

In an embodiment, the method may include capturing the audio-visual content in the first mode of operation prior to the change in the mode of operation from the first mode of operation to the second mode of operation. In an embodiment, the audio-visual content may be captured in the first mode of operation for a predetermined time. The predetermined time may be specified by a user or a device manufacturer. In an embodiment, the predetermined time may be automatically set based on available size of memory and/or processing capabilities of one or more processors.

In an embodiment, the output perceivable by the human may include a customized audio output, a display message, a visual display, or a vibratory signal generated by the device. In an embodiment, the output non-perceivable by the human may include at least one of a radio signal, or an infrared (IR) signal, and/or the like.

In an embodiment, the output non-perceivable by the human may be received by a multimedia device. The multimedia device may generate the output perceivable by the human based on the received output non-perceivable by the human. In an embodiment, the multimedia device may be a headphone or an earphone.

In an embodiment, the method may include determining a first plurality of audio characteristics of a customized audio output corresponding to the output perceivable by the human. In an embodiment, the method may include determining a second plurality of audio characteristics of one or more audio components of the captured audio-visual content.

In an embodiment, the first plurality of audio characteristics and the second plurality of audio characteristics of the one or more audio components may include amplitude characteristics, frequency characteristics, and/or phase shift characteristics associated with the customized audio output and the one or more audio components.

In an embodiment, the method may include filtering the customized audio output from the one or more audio components of the captured audio-visual content, based on the determination of the first plurality of audio characteristics and the determination of the second plurality of audio characteristics of the one or more audio components.

In an embodiment, the method may include filtering the customized audio output from the one or more audio components of the captured audio-visual content, based on the determination of the first plurality of audio characteristics, time duration of the customized audio output, and the determination of the second plurality of audio characteristics of the one or more audio components.

In an embodiment, the method may include automatically capturing one or more still images when the mode of operation of the device changes from the first mode of operation to the second mode of operation.

In an embodiment, the rendered output non-perceivable by the human may be electronically communicated to a user via a multimedia device based on one or more wireless technology standards.

Exemplary aspects of the disclosure may comprise a method for processing image content in a device. The method may include rendering an output perceivable by a human when the device switches between an image capture mode and a video capture mode of operation. The rendered output perceivable by the human may be a customized audio output. The method may include capturing the image content in the video capture mode. The method may further include filtering the rendered customized audio output from the captured content.

In an embodiment, the image content may include still image content and/or audio-visual content. In an embodiment, the image content may include storing the rendered customized audio output as one of the one or more audio components of the captured image content. In an embodiment, the method may include applying one or more noise cancellation techniques for filtering the rendered customized audio output from the one or more audio components. In an embodiment, the rendered customized audio output may be filtered from the one or more audio components of the captured image content based on a first metadata and a second metadata.

In an embodiment, the first metadata may include one or more of a first plurality of audio characteristics of the customized audio output, a genre of the customized audio output, a date and a time of customization of the customized audio output, a rendered time instance of the customized audio output, and/or a time duration of the customized audio output. In an embodiment, the second metadata may include one or more of a second plurality of audio characteristics of the one or more audio components of the captured image content, a day, a date and/or a time of the captured image content.

In an embodiment, the method may include switching from the image capture mode to the video capture mode in response to the one or more predetermined events. The one or more predetermined events may include detecting a predetermined user input, detecting a physical movement of the device, detecting a change in an orientation of the device, and/or detecting a change in one or more settings of the device.

In an embodiment, the method may include controlling the capture of the image content in the video capture mode, based on one or more time-stamps associated with the one or more predetermined events.

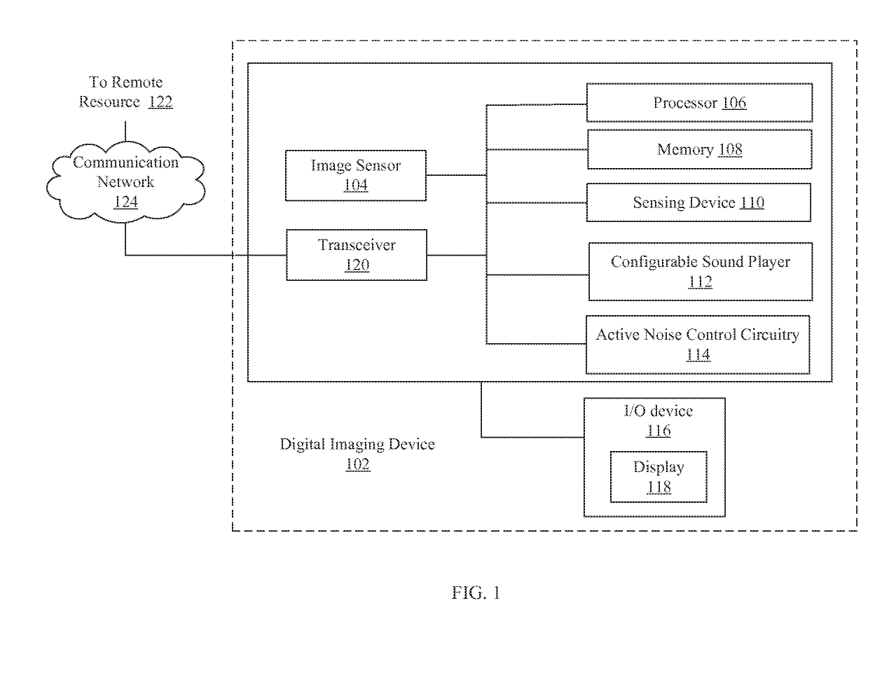

FIG. 1 is a block diagram of an exemplary device, in accordance with an embodiment of the disclosure. With reference to FIG. 1, there is shown a device 102. The device 102 may include an image sensor 104. The device 102 may further include one or more processors, such as a processor 106, a memory 108, one or more sensing devices, such as a sensing device 110, a configurable sound player 112, an active noise control circuitry 114, and one or more input/output (I/O) devices, such as an I/O device 116. The device 102 may further include a transceiver 120, a remote resource 122, and a communication network 124. The device 102 may further include a display 118, and an I/O device 116.

The device 102 may be associated with a user 126 (not shown). The device 102 may be connected to the remote resource 122, via the communication network 124 and the transceiver 120. The processor 106 may be coupled to the transceiver 120, the image sensor 104, the memory 108, the sensing device 110, the configurable sound player 112, the active noise control circuitry 114, and the display 118 of the I/O device 116.

The device 102 may comprise suitable logic, circuitry, interfaces, and/or code that may be operable to perform processing, storage, and display of image content. The image content may include a still image and an audio-visual content. The still image may be a single static image. The audio-visual content may include audio content and multiple dynamic images. Examples of the device 102 may include, but are not limited to, a touch screen-based digital image capturing device, a tablet computer, a smartphone, a camcorder, and a personal digital assistant (PDA) device.

The image sensor 104 may comprise suitable logic, circuitry, interfaces, and/or code that may be operable to capture an optical content of a physical scene, convert the captured optical content into electronic signals and subsequently transform the converted electronic signals into digital format. The digital format of the captured optical content may be referred to as the image content. The image sensor 104 may be realized through several known technologies such as, but not limited to, digital charge-coupled device (CCD) or complementary metal-oxide-semiconductor (CMOS) active pixel sensors.

The processor 106 may comprise suitable logic, circuitry, and/or interfaces that may be operable to execute at least one code section stored in the memory 108. The processor 106 may be realized through a number of processor technologies known in the art. Examples of processor 106 may be an X86 processor, a (reduced instruction set computer) RISC processor, an application-specific integrated circuit (ASIC) processor, a complex instruction set computer (CISC) processor, or any other processor.

In an embodiment, the processor 106 may determine a first plurality of audio characteristics of the customized audio output stored in the memory 108. The processor 106 may transmit the first plurality of audio characteristics of the customized audio output to the active noise control circuitry 114.

Examples of the first plurality of audio characteristics may include amplitude characteristics, frequency characteristics, and/or phase shift characteristics associated with the customized audio output. Notwithstanding, the disclosure may not be so limited, and other audio characteristics of the customized audio output may be determined without limiting the scope of the disclosure.

In an embodiment, the processor 106 may determine one or more audio components of the captured audio-visual content in the memory 108. The captured audio-visual content may include audio content and multiple dynamic images. The audio content may include one or more audio components. For example, an audio-visual content corresponding to a sea-shore scene may include one or more audio components such as a chirping sound of a bird, a crashing sound of a wave, rendered customized audio output (in response to the detected change in the mode of operation of the device 102), and/or an ambient noise. Each audio component may include a second plurality of audio characteristics.

In an embodiment, the processor 106 may determine the second plurality of audio characteristics of the one or more audio components of the captured audio-visual content. In an embodiment, processor 106 may store the second plurality of audio characteristics in the memory 108. In an embodiment, the processor 106 may transmit the stored second plurality of audio characteristics to the active noise control circuitry 114.

Similar to the examples of the first plurality of audio characteristics, examples of the second plurality of audio characteristics may include amplitude characteristics, frequency characteristics, and/or phase shift characteristics associated with the one or more audio components of the captured audio-visual content. Notwithstanding, the disclosure may not be so limited, and other audio characteristics of the one or more components of the captured audio-visual content may be determined without limiting the scope of the disclosure.

The memory 108 may comprise suitable logic, circuitry, and/or interfaces that may be operable to store a machine code and/or a computer program having at least one code section executable by the processor 106. The memory 108 may further be operable to store the one or more customized audio output, the captured still images, and the one or more audio components of the captured audio-visual content. Examples of implementation of the memory 108 may include, but are not limited to, Random Access Memory (RAM), Read Only Memory (ROM), Hard Disk Drive (HDD), and a Secure Digital (SD) card.

In an embodiment, the memory 108 may further be operable to store a first metadata of the one or more customized audio output and a second metadata of the one or more audio components of the captured audio-visual content. Examples of the first metadata may include, but are not limited to, a first plurality of audio characteristics, a genre, a date and a time of customization, a rendered time instance, and/or a time duration of the customized audio output. Notwithstanding, the disclosure may not be so limited, and other metadata of the customized audio output may be determined without limiting the scope of the disclosure.

Examples of the second metadata may include, but are not limited to, the second plurality of audio characteristics of the one or more audio components of the captured audio-visual content, a day, a date and/or a time of the captured audio-visual content. Notwithstanding, the disclosure may not be so limited, and other metadata of the captured audio-visual content may be determined without limiting the scope of the disclosure.

The sensing device 110 may comprise suitable logic, circuitry, and/or interfaces that may be operable to store a machine code and/or a computer program having at least one code section executable by the processor 106.

In an embodiment, the sensing device 110 may include one or more sensors, for example an accelerometer, to measure and store movement of the device 102, based on the acceleration experienced by the device 102. Notwithstanding, the disclosure may not be so limited, and other sensors may be utilized to measure movement of the device 102 without limiting the scope of the disclosure.

In an embodiment, the sensing device 110 may include a gyroscope for measuring or maintaining physical orientation of the device 102, based on the principles of angular momentum. For example, a quick vertical movement of the device 102 may change the operating mode of the device 102 into the image capture mode and a quick horizontal movement of the device 102 may change the operating mode of the device 102 into the video capture mode. Notwithstanding, the disclosure may not be so limited, and other sensors may be utilized to measure physical orientation of the device 102 without limiting the scope of the disclosure.

In an embodiment, the one or more sensors may include a camera to detect at least one of the following for biometric authentication of the user 126: a fingerprint, palm geometry, a two- or three-dimensional facial profile, characteristic features of the iris, and/or a retinal scan of the user 126.

In an embodiment, the sensing device 110 may include a microphone to detect a voice pattern of the audio-visual content captured by the device 102.

The sensing device 110 may implement various known biometric algorithms for user recognition, user identification and/or user verification. Examples of such algorithms include, but are not limited to, algorithms for face recognition, voice recognition, iris recognition, password matching, and fingerprint matching. It will be appreciated by those skilled in the art that any unique characteristic of the user may be accepted as a user input for identification purposes at least within the ongoing context.

The configurable sound player 112 may comprise suitable logic, circuitry, and/or interfaces that may be operable to render an output perceivable by a human, for example a customized audio output, in response to an instruction received from the processor 106. The processor 106 may issue the instruction upon detecting a change in the mode of operation of the device 102. In an embodiment, the change in the mode of operation of the device 102 may be from an image capture mode to a video capture mode of operation. The rendered customized audio output may be a simple beep, a pre-stored musical note, a pre-stored audio excerpt received from a multimedia application, a configurable sound, and the like. The customized audio output may be stored in the memory 108. Examples of such configurable sound player 112 may include, but are not limited to, Winamp Media Player®, RealPlayer® and Spider Player®. Notwithstanding, the disclosure may not be so limited, and other configurable sound players may be utilized to render the customized audio output without limiting the scope of the disclosure.

The active noise control circuitry 114 may comprise suitable logic, circuitry, and/or interfaces that may be operable to filter the customized audio output from the one or more audio components of the audio-visual content captured by the device 102 in the video capturing mode. In an embodiment, the active noise control circuitry 114 may receive the first plurality of audio characteristics of the customized audio output from the processor 106. The active noise control circuitry 114 may receive the second plurality of audio characteristics of the one or more audio components of the captured audio-visual content corresponding to the second mode of operation from the processor 106. In an embodiment, the active noise control circuitry 114 may receive the first metadata and the second metadata from the memory 108.

In an embodiment, the first plurality of audio characteristics of the customized audio output may match with the second plurality of audio characteristics of the one or more audio components of the captured audio-visual content. For example, the frequency of the customized audio output may match with the frequency of an audio component in the captured audio-visual content. In such instances, the active noise control circuitry 114 may apply one or more noise cancellation techniques for filtering such customized audio output from the one or more audio components of the captured audio-visual content. The customized audio output may be filtered from the one or more audio components based on the first metadata and the second metadata received from the memory 108.

In an embodiment, the first plurality of audio characteristics of the customized audio output may not match with the second plurality of audio characteristics of the one or more audio components of the captured audio-visual content due to ambient noise. For example, the frequency of the customized audio output may not match with the frequency of an audio component in the captured audio-visual content. In such instances, the active noise control circuitry 114 may apply one or more noise cancellation techniques for filtering the customized audio output from the one or more audio components of the captured audio-visual content. The customized audio output may be filtered from the one or more audio components based on the first metadata and the second metadata received from the memory 108.

In an embodiment, due to the intervening I/O device 116, for example a microphone, the first plurality of audio characteristics, and accordingly the customized audio output may get modified. Consequently, such a modified customized audio output may be stored as one of the one or more audio components of the captured audio-visual content in the memory 108. In such an embodiment, the active noise control circuitry 114 may apply one or more extrapolation methods on the first plurality of audio characteristics of the customized audio output. Such extrapolation may include estimating a new first plurality of audio characteristics based on current known values of the first plurality of audio characteristics. In such instances, the active noise control circuitry 114 may apply one or more noise cancellation techniques for filtering the modified customized audio output from the one or more audio components of the captured audio-visual content based on the new first plurality of audio characteristics. The modified customized audio output may be filtered from the one or more audio components based on the first metadata and the second metadata received from the memory 108.

Examples of such one or more extrapolation methods may include, but are not limited to, linear extrapolation, polynomial extrapolation, conic extrapolation, and french curve extrapolation. Notwithstanding, the disclosure may not be so limited, and other extrapolation methods may be applied by the active noise control circuitry 114 without limiting the scope of the disclosure.

In an embodiment, the active noise control circuitry 114 may also use a time component while applying the one or more noise cancellation techniques for filtering the customized audio output from the one or more audio components of the captured audio-visual content. The processor 106 may determine such time components corresponding to the time duration in the first metadata corresponding to the customized audio output stored in the memory 108. Reference time of such time components may be the instant when the mode of operation of the device 102 changes from the image capture mode to the video capture mode.

Examples of such one or more noise cancellation techniques may include, but are not limited to, Adaptive Noise Cancellation (ANC) technique, Phase Cancellation technique, and Adaptive Temporal Filtering (ATF) technique. Notwithstanding, the disclosure may not be so limited, and other noise cancellation techniques may be implemented in the active noise control circuitry 114 without limiting the scope of the disclosure.

The I/O device 116 may comprise various input and output devices operably connected to the processor 106. Examples of the I/O device 116 include, but are not limited to, a keyboard, a mouse, a joystick, a touch screen, a microphone, a camera, a motion sensor, a light sensor, and/or a docking station. Examples of output devices include, but are not limited to, the display 118 and a speaker.

The display 118 may comprise suitable logic, circuitry, interfaces, and/or code that, according to various embodiments, may be operable to act both as an input unit to accept one or more predetermined user input from the user 126 and as an output unit to display captured or stored image content to the user 126. The display 118 may be realized through several known technologies such as, but not limited to, Liquid Crystal Display (LCD) display, Light Emitting Diode (LED) display, and Organic LED (OLED) display technology. Further, the display 118 may be a touch-sensitive screen that may receive user input from the user 126 by means of a virtual keypad, a stylus, a touch screen, one or more gestures, and/or the like.

In an embodiment, the display 118 may be operable to render an output perceivable by a human, for example, a text message or a visual display, in response to an instruction received from the processor 106. The processor 106 may issue the instruction upon detecting a change in the mode of operation of the device 102.

The transceiver 120 may comprise suitable logic, circuitry, interfaces, and/or code that may be operable to communicate with the remote resource 122 through a communication network 124. The transceiver 120 may implement known technologies to support wired or wireless communication of the device 102 with the communication network 124. In particular, a communication interface of the transceiver 120 may be a wireless or a wired interface.

In an embodiment, the transceiver 120 may be operable to render an output non-perceivable by a human, for example, a radio signal or an infrared signal, in response to an instruction received from the processor 106. The processor 106 may issue the instruction upon detecting a change in the mode of operation of the device 102.

The remote resource 122 may comprise suitable logic, circuitry, interfaces, and/or code that may be operable to store image content captured and processed by the device 102. The remote resource 122 may be implemented using several technologies that are well known to those skilled in the art. Some examples of these technologies may include, but are not limited to, MySQL® and Microsoft SQL®.

The communication network 124 is a medium through which the device 102 may communicate with the remote resource 122 and/or other devices. Examples of the communication network 124 may include, but are not limited to, a television broadcasting system, an Internet Protocol television (IPTV) network, the Internet, a Wireless Fidelity (Wi-Fi) network, a Wireless Area Network (WAN), a Local Area Network (LAN), a telephone line (POTS), or a Metropolitan Area Network (MAN). The communication between the device 102 and the remote resource 122 and/or other devices via the communication network 124 may be performed, in accordance with various wired and wireless communication protocols, such as Transmission Control Protocol and Internet Protocol (TCP/IP), User Datagram Protocol (UDP), 2G, 3G, or 4 G communication protocols.

In operation, the device 102 confirms the user 126 as an authenticated user, based on biometric data acquired by the sensing device 110. In an embodiment, the biometric data acquired by the sensing device 110 may be verified by the processor 106. In instances, when the processor 106 successfully verifies the biometric data, the user 126 is authenticated. Otherwise, the user 126 is denied an access to the device 102. Once authenticated, the user 126 is enabled to perform one or more predetermined events to operate the device 102 in dual modes. Various examples of the one or more predetermined events may include, but are not limited to, one or more predetermined user input, physically moving the device 102, adjusting orientation of the device 102 or modifying one or more device settings of the device 102.

According to various embodiments, the one or more predetermined user input events may include a touch input, a touch-less input or a speech input. The touch input may include performing touch gestures on one or more hardware buttons of the device 102 or the touch-screen of the device 102. The touch-less input may include a set of touch-less gestures on a pre-defined proximity of the device 102. The set of touch-less gestures may include a hand gesture, a finger gesture, a facial gesture and/or a body gesture. In an embodiment, speech input may include a voice pattern of the user 126.

In an embodiment, one of the one or more predetermined user input events may include a combination of optical content being captured by the image sensor and motion data determined by the sensing device 110. Such combination data may be used in an instance when movement of the user 126 intending to follow a subject in the physical scene is detected. Such combination data may be used to automatically trigger the video capture mode of the device 102.

The device 102 may include an application that may enable the device 102 to interpret the one or more predetermined events. In an embodiment, the application may be installed by a manufacturer of the device 102. In another embodiment, the user 126 may install the application on the device 102. The application may provide the user 126 a platform to communicate with the device 102. Examples of the application may be implemented based on a 3D model-based algorithm, a skeletal-based algorithm or an appearance-based model. Notwithstanding, the disclosure may not be so limited, and other algorithms may be utilized without limiting the scope of the disclosure

The user 126 may operate the device 102 as a device administrator. In an embodiment, the user 126 may be an owner of the device 102. The user 126 may configure a personal computing environment that includes the device 102.

The device 102 may operate in a plurality of modes in response to the one or more predetermined events. For the sake of brevity, the disclosure discusses only two modes. In an embodiment, the device 102 may be operable in an image capture mode for capturing image content of a physical scene, for example, a still image of a crashing wave on a rock on a beach. In an embodiment, the device 102 may be operable in an video capture mode for capturing audio-visual content of the physical scene, for example video image of a crashing wave on a rock on a beach and an associated crashing sound of the wave.

In response to at least one of the one or more predetermined events, the image sensor 104 in the device 102 may capture the optical content of the physical scene. The image sensor 104 may convert the captured optical content into electronic signals and subsequently transform the converted electronic signals into the digital format. As previously discussed, the digital format of the captured optical content may be referred to as the image content.

In an embodiment, the processor 106 may capture the image content in the image capture mode and in the video capture mode simultaneously at a pre-defined physical orientation of the device 102. In such instances, the audio-visual content, which corresponds to the video capture mode, may be generated passively based on the one or more predetermined events.

In such an embodiment, the processor 106 may capture the audio-visual content even in the image capture mode also. The processor 106 may temporarily store the captured audio-visual content in the memory 108. Thus, the audio-visual content may be captured by the processor 106 even before the change in the mode of operation of the device 102 from the image capture mode to the video capture mode is detected. The audio-visual content may be captured by the device 102 in the image capture mode for a predetermined time. The predetermined time may be specified by the user 126 or one or more factory settings specified by a manufacturer of the device 102. The predetermined time may be automatically set based on available size of the memory 108 and/or processing capabilities of the processor 106.

In an embodiment, the device 102 may record a still image immediately upon detection of the one or more predetermined events. After the still image is taken, the device 102 may automatically switch to the video capture mode and start recording the audio-visual content. If the one or more predetermined events are performed for a predetermined time period, such as for more than one second, for example, the still image may be discarded since the user 126 intends to record the audio-visual content. If the one or more predetermined events are before the end of the predetermined time period, one second, for example, then the recorded audio-visual content (which is less than one second, for example) may be discarded since the user 126 intends to capture a still image.

In an embodiment, the device 102 may keep capturing the still image content such that the captured still image content may be used when the mode of operation of the device 102 is changed from the first mode of operation to the second mode of operation. The device 102 may capture the still image content based on size of the memory 108, processing capabilities of the processor 106, and one or more specifications specified by the user 126. The device 102 may discard the captured still image content if no one or more predetermined events are performed for a predetermined time period. In instances, when the one or more predetermined events are performed for the predetermined time period, the device 102 may change the mode of the operation from the first mode of operation to the second mode of operation. Despite of the change in the mode of operation, the device 102 may still retain the still image content captured in the first mode of operation of the device 102. The device 102 may also capture still image content during the change the mode of the operation from the first mode of operation to the second mode of operation. In such instances, the device may stitch together the still image content captured in the first mode of operation and the still image content during the change the mode of the operation, with the audio-visual content captured in the second mode of operation. The audio content of the audio-visual content may be gradually increased from zero decibels to higher decibels to present the user 126 a seamless and natural viewing experience.

In an embodiment, the processor 106 may switch from the image capture mode of operation to the video capture mode in response to the one or more predetermined events. In an embodiment, the processor 106 may detect the change in the operating mode, for example from the image capture mode to the video capture mode of the device 102.

In an embodiment, in response to the detected change in the mode of operation of the device 102, the processor 106 may instruct the transceiver 120 to render an output non-perceivable by the human, for example, a radio signal or an infrared signal. The rendered output may be communicated to the user 126 electronically using a wireless standard, such as a radio signal or an infrared signal, and/or the like. Such an embodiment may prevent the customized audio output from being picked up by the microphone of the device 102 in the video capture mode. For example, the user 126 may plug a Bluetooth headphone/earphone directly into the device 102. The device 102 may communicate the customized audio output either directly to the Bluetooth headphone/earphone or to another device, such as a cell phone that is paired with the Bluetooth headphone/earphone. Thus, the user 126 may hear the customized audio output from the device 102 without the customized audio output being picked up by the microphone of the device 102 in the video capture mode.

In an embodiment, in response to the detected change in the mode of operation of the device 102, the processor 106 may instruct the display 118 to render an output perceivable by a human, for example, a text message or a visual display.

In an embodiment, in response to the detected change in the mode of operation of the device 102, the processor 106 may instruct an internal circuitry of the device 102 to render an output perceivable by a human, for example, a vibratory signal.

In an embodiment, in response to the detected change in the mode of operation of the device 102, the processor 106 may instruct the configurable sound player 112 to render a output perceivable by a human, for example, a customized audio output. In an embodiment, the customized audio output may be same for each detected change in the mode of operation of the device 102. In an embodiment, the customized audio output may be different for each detected change in the mode of operation of the device 102.

In an embodiment, the image sensor 104 may be operable to automatically capture one or more still images when the processor 106 detects the change in the mode of operation of the device 102. The change in the mode of operation of the device 102 may be from the image capture mode to the video capture mode or from the video capture mode to the image capture mode. In an embodiment, the one or more still images may correspond to an image content captured before and/or after the change in the mode of operation is performed. In an embodiment, the one or more still images may correspond to an image content captured during the change in the mode of the operation. The automatically captured one or more still images may be stored in the memory 108 and associated with a distinct identifier. The distinct identifier may uniquely identify the automatically captured one or more still images. The distinct identifier may differentiate the automatically captured one or more still images from other images intentionally captured by the user 126.

In an embodiment, the device 102 may store the captured image content in the memory 108. In an embodiment, the device 102 may store the captured image content in the remote resource 122. In an embodiment, the remote resource 122 may be connected to the device 102 via the transceiver 120. In another embodiment, the remote resource 122 may be integrated with the memory 108 of the device 102.

Unlike other film-based imaging devices, the device 102 may display the image content on the display 118 immediately after being captured or stored. In an embodiment, the device 102 may store and delete captured or stored image content in and from the memory 108.

In an embodiment, the processor 106 may be operable to passively store the captured image content in memory 108 in current time, based on occurrence of the one or more predetermined events. The one or more predetermined events may trigger the video capture mode of the device 102 in subsequent time.

In an embodiment, the processor 106 may determine one or more time-stamps in the captured audio-visual content and store in the memory 108, based on an occurrence of the one or more predetermined events. The stored one or more time-stamps may be used to determine one or more key frames in the captured audio-visual content. In an embodiment, the one or more key frames may be one or more still images in the captured audio-visual content. In an embodiment, the one or more key frames in the captured audio-visual content may be based on physical movement, for example at the beginning and end of a pan movement of the device 102. In an embodiment, the one or more key frames in the captured audio-visual content may be based on modification of the one or more device settings. For example, an automatic switching of white balance of the device 102 may trigger the device 102 to determine one or more key frames in the captured audio-visual content.

In an embodiment, the processor 106 may be operable to determine the one or more key frames in the captured audio-visual content, based on physical movement of the device 102 and modification of one or more device settings of the device 102. The one or more device settings of the device 102 may include auto exposure, auto focus, auto white balance, auto tuning, and/or the like. Notwithstanding, the disclosure may not be so limited, and other device settings may be utilized without limiting the scope of the disclosure.

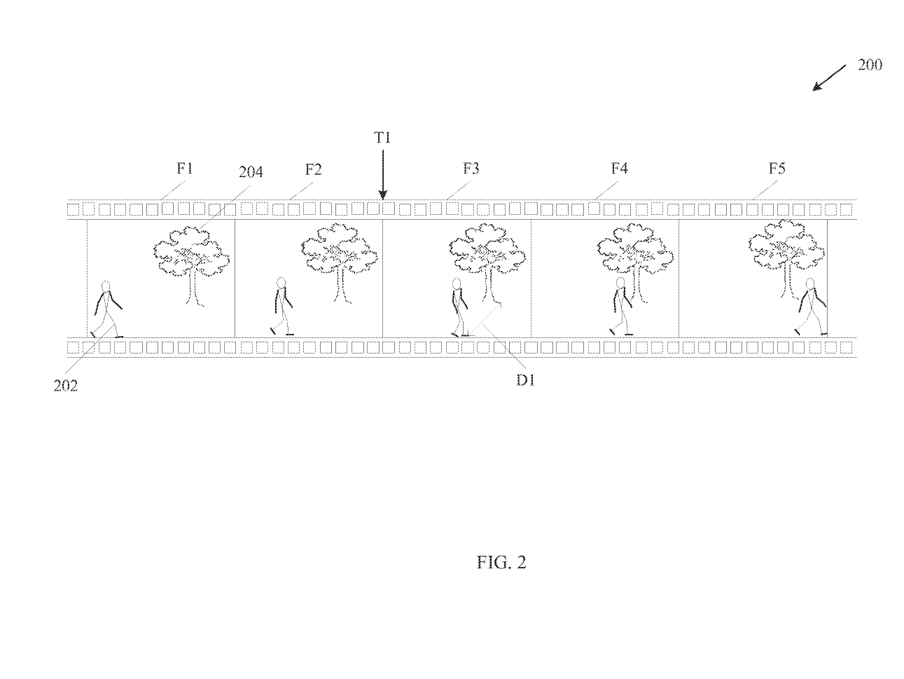

FIG. 2 illustrates an exemplary instance 200 of the device 102 for determining a key frame in a captured audio-visual content. The captured audio-visual content, as illustrated in the instance 200, may include a sequence of frames F1, F2, F3, F4, and F5. The instance 200 may include a movement of a foreground object (such as an actor 202, for example) walking past a background object (such as a tree 204, for example). The sequence of frames F1, F2, F3, F4, and F5 of the audio-visual content may be captured and stored at an occurrence of a predetermined event, for example the stand-still position of the device 102. At another predetermined event, for example pressing of a hardware or software button, a time-stamp T1 corresponding to the frame F3 may be stored when the actor 202 is at a distance D1 from the tree 204. The frame F3 may be determined as a key frame and may be stored as a still image in the memory 108.

With reference to FIG. 1, based on the one or more stored time-stamps, the processor 106 may control the capturing of the audio-visual content in the video capture mode.

In an embodiment, the processor 106 may determine the first metadata of the customized audio output the second metadata of the one or more audio components of the captured audio-visual content. The processor 106 may store the first metadata and the second metadata in the memory 108.

In an embodiment, the processor 106 may transmit the first metadata and the second metadata to the active noise control circuitry 114. In an embodiment, the active noise control circuitry 114 may determine the first metadata and the second metadata from the memory 108.

The active noise control circuitry 114 may filter the rendered customized audio output from the one or more audio components of the captured audio-visual content by applying one or more noise cancellation techniques. The rendered customized audio output may be filtered from the one or more audio components of the captured audio-visual content based on the first metadata and the second metadata received from the memory 108. Consequently, the rendered customized audio output may be filtered from the one or more audio components of the captured audio-visual content to present a seamless listening/viewing experience to the user 126.

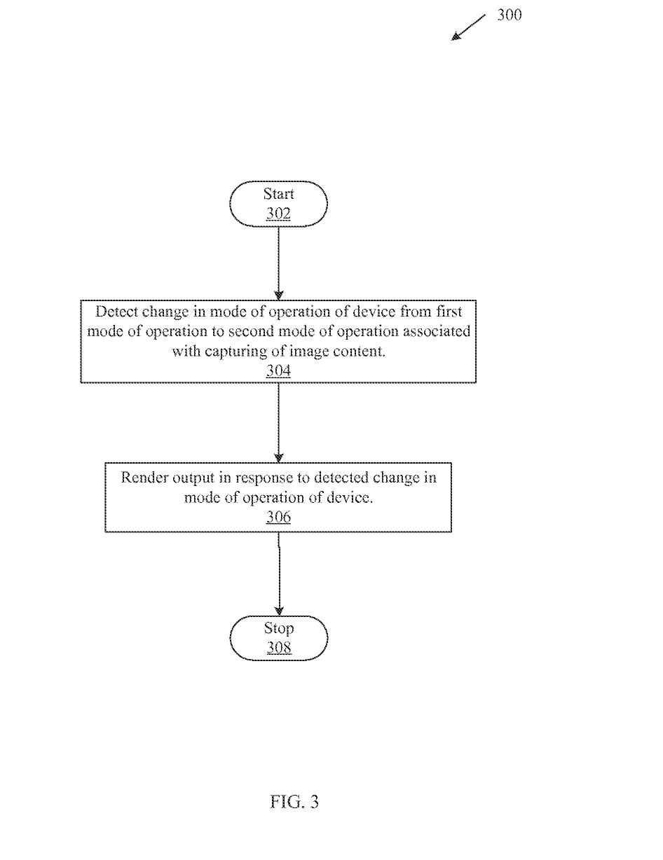

FIG. 3 is an exemplary flow chart illustrating exemplary steps for processing image content, in accordance with an embodiment of the disclosure. FIG. 3 is explained in conjunction with elements from FIG. 1. With reference to FIG. 3, exemplary steps begin at step 302. The method proceeds to step 304.

At step 304, the processor 106 in the device 102 may detect a change in a mode of operation of the device associated with capturing of the image content. In an embodiment, the change in the mode of operation may be from an image capture mode of operation to a video capture mode of operation in response to one or more predetermined events.

At step 306, the processor 106 in the device 102 may instruct the configurable sound player 112 to render an output in response to the detected change in the mode of operation of the device 102. In an embodiment, the rendered output may be an output perceivable by a human. In an embodiment, the rendered output may be an output non-perceivable by the human. Control then passes to end step 308.

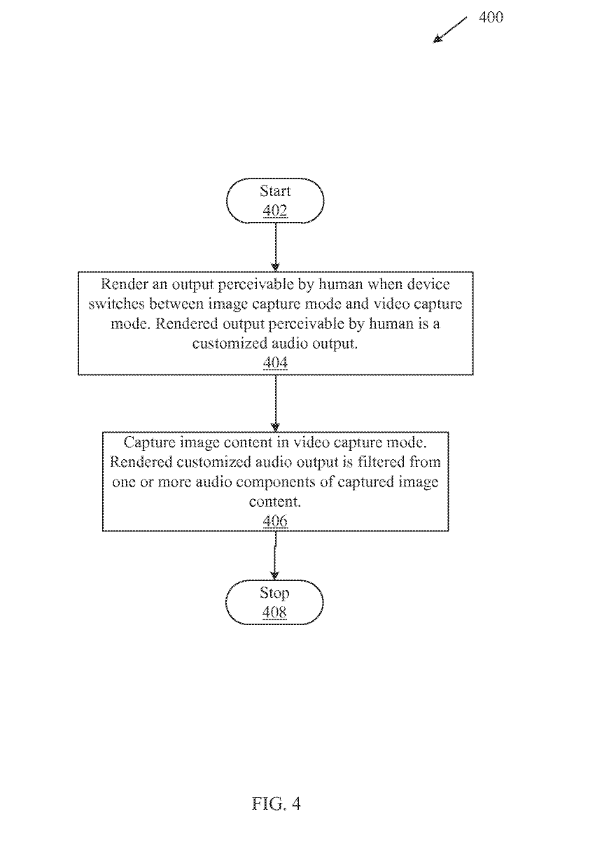

FIG. 4 is another flow chart illustrating exemplary steps for processing image content, in accordance with an embodiment of the disclosure. FIG. 4 is explained in conjunction with elements from FIG. 1. With reference to FIG. 4, exemplary steps may begin at step 402. The method proceeds to step 404.

At step 404, an output perceivable by a human may be rendered when the device switches between an image capture mode and a video capture mode of operation.

In an embodiment, the output perceivable by a human may be a customized audio output. The customized audio output may be rendered by the configurable sound player 112 in response to the detected mode change. The processor 106 may determine the first metadata corresponding to the rendered customized audio output stored in the memory 108 and transmit the determined first metadata to the active noise control circuitry 114.

At step 406, the image content may be captured in the video capture mode and the rendered customized audio output may be filtered from the one or more audio components of the captured image content.

In an embodiment, processor 106 may determine the second metadata corresponding to the one or more audio components of the image content captured in the video capture mode. The processor 106 may store the second metadata in the memory 108. In an embodiment, the processor 106 may transmit the second metadata to the active noise control circuitry 114.

In an embodiment, the rendered customized audio output and the one or more audio components of the image content captured in the video capture mode may be stored in the memory 108.

In an embodiment, the customized audio output may be stored in the memory 108 as one of the one or more audio components of the image content captured in the video capture mode.

In an embodiment, the active noise control circuitry 114 may receive the first metadata corresponding to the customized audio output and the second metadata corresponding to the one or more audio components of the captured audio-visual content from the processor 106.

In an embodiment, the active noise control circuitry 114 may determine the first metadata corresponding to the customized audio output and the second metadata corresponding to the one or more audio components of the captured audio-visual content from the memory 108.

In an embodiment, the first plurality of audio characteristics of the customized audio output may match with the second plurality of audio characteristics of the one or more audio components of the captured audio-visual content. For example, the frequency of the customized audio output may match with the frequency of an audio component in the captured audio-visual content. In such instances, the active noise control circuitry 114 may apply one or more noise cancellation techniques for filtering such customized audio output from the one or more audio components of the captured audio-visual content. The customized audio output may be filtered from the one or more audio components based on the first metadata and the second metadata stored in the memory 108.

In an embodiment, the first plurality of audio characteristics of the customized audio output may not match with the second plurality of audio characteristics of the one or more audio components of the captured audio-visual content due to ambient noise. Due to intervening I/O device 116, for example a microphone, the first plurality of audio characteristics, and accordingly the customized audio output may get modified while being stored in the memory 108. Consequently, such modified customized audio output may be stored as one of the one or more audio components of the captured audio-visual content in the memory 108. In such embodiment, the active noise control circuitry 114 may apply one or more extrapolation methods on the first plurality of audio characteristics of the customized audio output. Such extrapolation may include estimating a new first plurality of audio characteristics based on known values of the first plurality of audio characteristics. In such instances, the active noise control circuitry 114 may apply one or more noise cancellation techniques for filtering the modified customized audio output from the one or more audio components of the captured audio-visual content based on the new first plurality of audio characteristics. The modified customized audio output may be filtered from the one or more audio components based on the first metadata and the second metadata stored in the memory 108.

In an embodiment, the active noise control circuitry 114 may also use time duration from the first metadata corresponding to the customized audio output while applying the one or more noise cancellation techniques. The active noise control circuitry 114 may apply the one or more noise cancellation techniques for filtering the customized audio output from the one or more audio components of the captured audio-visual content.

Accordingly, such filtration of the customized audio output from the one or more audio components of the captured audio-visual content may result in a seamless user experience while operating the device 102 in a video capture mode.

In accordance with an embodiment of the disclosure, a device for processing image content is presented. Exemplary aspects of the disclosure may comprise the one or more processors and/or circuits, such as the processor 106, in the device (such as device 102). The processor 106 may be operable to detect a change in a mode of operation of the device from a first mode of operation to a second mode of operation associated with capturing of the image content. The processor 106 may be operable to render an output in response to the detected change in the mode of operation of the device 102. The rendered output may be one or more of an output perceivable by a human or an output non-perceivable by the human.

In an embodiment, the first mode of operation of the device 102 may be an image capture mode. Such image capture mode may be associated with capturing of image content. In an embodiment, the second mode of operation of the device 102 may be a video capture mode. Such video capture mode may be associated with capturing of audio-visual content.

In an embodiment, the processor 106 may be operable to switch from the first mode of operation to the second mode of operation in response to one or more predetermined events.

In an embodiment, the one or more predetermined events may include detecting a predetermined user input, detecting a physical movement of the device, detecting a change in an orientation of the device, and/or detecting a change in one or more settings of the device. In an embodiment, the one or more predetermined user input events may include a set of gestures. The set of gestures may include a hand gesture, a finger gesture, a facial gesture and/or a body gesture.

In an embodiment, the processor 106 may be operable to store one or more time-stamps in the captured audio-visual content, based on an occurrence of the one or more predetermined events in the memory 108.

In an embodiment, the processor 106 may be operable to control the capture of the audio-visual content, based on the stored one or more time-stamps.

In an embodiment, the processor 106 may be operable to capture the image content in the first mode of operation and the second mode of operation simultaneously.

In an embodiment, the processor 106 may be operable to capture the audio-visual content in the first mode of operation prior to the change in the mode of operation from the first mode of operation to the second mode of operation. In an embodiment, the audio-visual content may be captured in the first mode of operation for a predetermined time. The predetermined time may be specified by a user or a device manufacturer. In an embodiment, the predetermined time may be automatically set based on available size of the memory 108 and/or processing capabilities of the one or more processors/circuits.

In an embodiment, the output perceivable by the human may include a customized audio output, a display message, a visual display, or a vibratory signal generated by the device. In an embodiment, the output non-perceivable by the human may include at least one of a radio signal, or an infrared (IR) signal.

In an embodiment, the output non-perceivable by the human may be received by a multimedia device. The multimedia device may generate the output perceivable by the human based on the received output non-perceivable the human. In an embodiment, the multimedia device may be a headphone or an earphone.

In an embodiment, the processor 106 may be operable to determine a first plurality of audio characteristics of the customized audio output and a second plurality of audio characteristics of the one or more audio components of the captured audio-visual content corresponding to the second mode of operation. In an embodiment, the first plurality of audio characteristics and the second plurality of audio characteristics of the one or more audio components may include amplitude characteristics, frequency characteristics, and/or phase shift characteristics associated with the customized audio output and the one or more audio components.

In an embodiment, the active noise control circuitry 114 may be operable to filter the customized audio output from the one or more audio components of the captured audio-visual content, based on the determination of the first plurality of audio characteristics and the determination of the second plurality of audio characteristics of the one or more audio components.

In an embodiment, the active noise control circuitry 114 may include filtering the customized audio output from the one or more audio components of the captured audio-visual content, based on the determination of the first plurality of audio characteristics, a time duration of the customized audio output, and the determination of the second plurality of audio characteristics of the one or more audio components.

In an embodiment, the processor 106 may be operable to automatically capture one or more still images when the mode of operation of the device 102 changes from the first mode of operation to the second mode of operation.

In an embodiment, the processor 106 may be operable to electronically communicate the customized audio output to the user 126 directly based on one or more wireless technology standards.

In accordance with another embodiment of the disclosure a device for processing image content is presented. Exemplary aspects of the disclosure may comprise the one or more processors and/or circuits, such as the processor 106, in the device 102. The one or more processors and/or circuits may be operable to render an output perceivable by a human when the device switches between the image capture mode and the video capture mode. The rendered output perceivable by a human may be a customized audio output. The one or more processors and/or circuits may be operable to capture the image content in the video capture mode. The one or more processors and/or circuits may be operable to filter the rendered customized audio output from the one or more audio components of the captured image content.

In an embodiment, the image content may include still image content and/or audio-visual content.

In an embodiment, the image content may include storing the rendered customized audio output as one of the one or more audio components of the captured image content.

In an embodiment, the active noise control circuitry 114 may be operable to apply one or more noise cancellation techniques for filtering the rendered customized audio output from the one or more audio components. In an embodiment, the rendered customized audio output may be filtered from the one or more audio components of the captured image content based on a first metadata and a second metadata.

In an embodiment, the first metadata may include a first plurality of audio characteristics of the customized audio output, a genre of the customized audio output, a date and a time of customization of the customized audio output, a rendered time instance of the customized audio output, and/or a time duration of the customized audio output. In an embodiment, the second metadata may include a second plurality of audio characteristics of the one or more audio components of the captured image content, a day, a date and/or a time of the captured image content.

In an embodiment, the processor 106 may be operable to switch from the image capture mode to the video capture mode in response to the one or more predetermined events. The one or more predetermined events may include detecting a predetermined user input, detecting a physical movement of the device, detecting a change in an orientation of the device, and/or detecting a change in one or more settings of the device.

In an embodiment, the processor 106 may be operable to control the capture of the image content in the video capture mode, based on one or more time-stamps associated with the one or more predetermined events.

Other embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for processing image content, may thereby cause the machine and/or computer to perform the steps comprising detecting a change in a mode of operation of the device associated with capturing of the image content, and rendering an output in response to the detected change in the mode of operation of the device.

Other embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for processing image content, may thereby cause the machine and/or computer to perform the steps comprising rendering an output perceivable by a human when said device switches between an image capture mode and a video capture mode, capturing the image content in the video capture mode, and filtering the rendered output from the one or more audio components of the captured image content.

The present disclosure may be realized in hardware, or a combination of hardware and software. The present disclosure may be realized in a centralized fashion, in at least one computer system, or in a distributed fashion, where different elements may be spread across several interconnected computer systems. A computer device or other apparatus adapted for carrying out the methods described herein may be suited. A combination of hardware and software may be a general-purpose computer device with a computer program that, when being loaded and executed, may control the computer device such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer device is able to carry out these methods. Computer program, in the present context, means any expression, in any language, code or notation, of a set of instructions intended to cause a device having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A device for processing image content, said device comprising:
one or more processors operable to:
detect a change in a mode of operation of said device from a first mode of operation to a second mode of operation associated with capturing of said image content; and
render an output in response to said detected change in said mode of operation of said device, wherein said output is one or both of: an audio output or an output non-perceivable by a human.

2. The device of claim 1, wherein said first mode of operation of said device is an image capture mode and said second mode of operation of said device is a video capture mode, wherein said image capture mode is associated with capturing of still image content and said video capture mode is associated with capturing of audio-visual content.

3. The device of claim 2, wherein said one or more processors are operable to change said mode of operation from said first mode of operation to said second mode of operation in response to one or more predetermined events.

4. The device of claim 3, wherein said one or more predetermined events comprises one or more of: detecting a predetermined user input, detecting a movement of one or more objects in said image content, detecting a physical movement of said device, detecting a change in an orientation of said device and/or detecting a change in one or more settings of said device.

5. The device of claim 4, wherein said predetermined user input comprises a set of gestures, wherein said set of gestures comprises one or more of: hand gestures, finger gestures, facial gestures and/or body gestures.

6. The device of claim 2, wherein said one or more processors are operable to store one or more time-stamps in said captured audio-visual content based on an occurrence of said one or more predetermined events.

7. The device of claim 6, wherein said one or more processors are operable to control capturing of said audio-visual content based on said stored one or more time-stamps.

8. The device of claim 2, wherein said one or more processors are operable to capture said image content in said first mode of operation and said second mode of operation simultaneously.

9. The device of claim 3, wherein said one or more processors are operable to capture said audio-visual content in said first mode of operation prior to said change in said mode of operation from said first mode of operation to said second mode of operation.

10. The device of claim 9, wherein said audio-visual content is captured in said first mode of operation for a predetermined time.

11. The device of claim 10, wherein said predetermined time is specified by a user or a device manufacturer.

12. The device of claim 9, wherein said predetermined time is automatically set based on an available size of memory and/or processing capabilities of said one or more processors.

13. The device of claim 1, wherein an output perceivable by said human comprises one or more of: a customized audio output, a display message, a visual display, or a vibratory signal generated by said device.

14. The device of claim 1, wherein said output non-perceivable by said human comprises one or both of: a radio signal or an infrared (IR) signal.

15. The device of claim 14, wherein said output non-perceivable by said human is received by a multimedia device.

16. The device of claim 15, wherein said multimedia device generates output perceivable by said human based on said received output non-perceivable by said human.

17. The device of claim 16, wherein said multimedia device is a headphone or an earphone.

18. The device of claim 2, wherein said one or more processors are operable to determine a first plurality of audio characteristics of a customized audio output corresponding to the output perceivable by said human and a second plurality of audio characteristics of one or more audio components of said captured audio-visual content.

19. The device of claim 18, wherein said determined said first plurality of audio characteristics and said determined said second plurality of audio characteristics of said one or more audio components comprise one or more of: amplitude characteristics, frequency characteristics, and/or phase shift characteristics associated with said customized audio output and said one or more audio components.

20. The device of claim 19, wherein said one or more processors are operable to filter said customized audio output from said one or more audio components of said captured audio-visual content based on said determined said first plurality of audio characteristics and said determined second plurality of audio characteristics.

21. The device of claim 19, wherein said one or more processors are operable to filter said customized audio output from said one or more audio components of said captured audio-visual content based on determination of said first plurality of audio characteristics of said customized audio output, time duration of said customized audio output, and said second plurality of audio characteristics of said one or more audio components.

22. A method comprising:
in a device:
detecting a change in a mode of operation of said device from a first mode of operation to a second mode of operation associated with capturing of image content; and
render an output in response to said detected change in said mode of operation of said device, wherein said output is one or both of: an audio output or an output non-perceivable by a human.

23. The method of claim 22, wherein said first mode of operation of said device is an image capture mode and said second mode of operation of said device is a video capture mode, wherein said image capture mode is associated with capturing of still image content and said video capture mode is associated with capturing of audio-visual content.

24. The method of claim 22, comprising storing one or more time-stamps in said captured audio-visual content based on an occurrence of said one or more predetermined events.

25. The method of claim 22, comprising automatically capturing one or more still images when said mode of operation of said device changes from said first mode of operation to said second mode of operation.

26. The method of claim 22, wherein said rendered output non-perceivable by said human is electronically communicated to a user via a multimedia device based on one or more wireless technology standards.

27. A device for processing image content, said device comprising:
one or more processors in said device operable to:
render one or both of: a customized audio output or an output non-perceivable by a human when said device switches between an image capture mode and a video capture mode; and
capture said image content in said video capture mode, wherein said rendered customized audio output is filtered from one or more audio components of said captured said image content.

28. The device of claim 27, wherein said rendered customized audio output is filtered from said captured said image content based on one or more noise cancellation techniques.

29. The device of claim 27, wherein said one or more processors are operable to switch from said image capture mode to said video capture mode in response to one or more predetermined events.

30. The device of claim 29, wherein said one or more predetermined events comprises one or more of: detecting a predetermined user input, detecting a physical movement of said device, detecting a change in an orientation of said device and/or detecting a change in one or more settings of said device.

31. The device of claim 29, wherein said one or more processors are operable to control capturing of said image content in said video capture mode based on one or more time-stamps associated with said one or more predetermined events.

32. The device of claim 30, wherein said one or more settings of said device comprises one or more of: an auto exposure, an auto focus, an auto white balance and/or an auto tuning.

33. A method comprising:
in a device:
render one or both of: a customized audio output or an output non-perceivable by a human when said device switches between an image capture mode and a video capture mode; and
capturing image content in said video capture mode, wherein said rendered output is filtered from one or more audio components of said captured said image content.

34. The method of claim 33, wherein said image content comprises still image content and/or audio-visual content.

35. The method of claim 33, comprising storing said rendered output as one of said one or more audio components of said captured said image content.

36. The method of claim 33, comprising applying one or more noise cancellation techniques for filtering said rendered customized audio output from said one or more audio components.

37. The method of claim 36, wherein said rendered customized audio output is filtered from said one or more audio components of said captured said image content based on a first metadata and a second metadata.

38. The method of claim 37, wherein said first metadata comprises one or more of: a first plurality of audio characteristics of said rendered output, a genre of said rendered customized audio output, a date and a time of customization of said rendered customized audio output, a rendered time instance of said rendered customized audio output, and/or a time duration of said rendered customized audio output.

39. The method of claim 37, wherein said second metadata comprises one or more of: a second plurality of audio characteristics of said one or more audio components of said captured said image content, a day, a date and/or a time of said captured said image content.
